(19) United States
(12) Patent Application Publication
(10) Pub. No.: US 2007/0243122 A1
(43) Pub. Date: Oct. 18, 2007

(54) Process for the synthesis and methanolysis of ammonia borane and borazine

(76) Inventors: P. Veeraraghavan Ramachandran, West Lafayette, IN (US); Pravin D. Gagare, West Lafayette, IN (US); China Raju Bhimapaka, West Lafayette, IN (US)

Correspondence Address: BRINKS HOFER GILSON & LIONE, P.O. BOX 10395, CHICAGO, IL, 60610, US

(21) Appl. No.: 11/716,873

(22) Filed: Mar. 12, 2007

Related U.S. Application Data
(60) Provisional application No. 60/781,834, filed on Mar. 13, 2006.
(60) Provisional application No. 60/817,911, filed on Jun. 30, 2006.

(51) Int. Cl. C01B 35/14

(52) U.S. Cl. 423/285

(57) ABSTRACT

The present invention provides an improved process for the synthesis and methanolysis of ammonia borane and borazine.

### CROSS-REFERENCE TO RELATED APPLICATIONS

This application claims priority to both U.S. Provisional Application Ser. No. 60/781,834, filed Mar. 13, 2006, and U.S. Provisional Application Ser. No. 60/817,911, filed Jun. 30, 2006, the entirety of both of which is incorporated herein by reference.

### FIELD OF THE INVENTION

The present invention relates to an improved process for the synthesis and methanolysis of ammonia borane and borazine.

### BACKGROUND OF THE INVENTION

Hydrogen is the environmentally desirable fuel of choice since it can be used in internal combustion engines or electrochemically oxidized efficiently in Proton Exchange Membrane, or other types of fuel cells. Currently available hydrogen storage processes are either inadequate or impractical for widespread usage. The United States Department of Energy (DOE) has targeted a gravimetric density of 6% for on-board hydrogen storage. Higher hydrogen weight percentage is required for lightweight power supplies, particularly to meet the requirements of soldiers in the field.

Although many hydride complexes have been studied, amine-boranes, particularly ammonia-borane (Borazane) (19.6 wt. % of H₂), is found to have unique potential to store and deliver a large amount of molecular hydrogen through dehydrogenation reactions. Accordingly, ammonia-borane has been examined as a hydrogen source. Ammonia-borane, a white crystalline transportable solid of low specific weight, is stable in ambient air. Furthermore, the non-toxicity of ammonia-borane makes it a superior carrier of hydrogen compared to ammonia. It liberates hydrogen through a stepwise sequence of reactions that occur at distinct temperature ranges.

The current cost of ammonia-borane (about $11.6/g) is disproportional to the starting material costs. An efficient large-scale preparation of ammonia-borane is needed to make it a viable hydrogen storage material, thus a major contributor to the hydrogen economy.

An efficient and economic synthetic protocol is highly crucial for ammonia-borane to become the material of choice for hydrogen storage. Although several synthetic procedures are known, all of them have drawbacks, such as the difficulty in the isolation and purification steps. Stringent conditions required for the preparation might have precluded the bulk preparation.

Reactions between lithium borohydride and ammonium salts, such as ammonium chloride, sulfate or carbonate for ammonia-borane synthesis are well known (equations 1-2). However, the yields for these reactions are rather low (˜45%) with work-up at very low temperatures (−78° C.) and a long reaction period (24 hours). Preparation from diammoniate of diborane [(H₂B(NH₃)₂⁺BH₄⁻] has also been known (equations 3-4). A synthetic procedure from diborane and ammonia in hexane has also been known. Other procedures used to make ammonia borane involve the reaction of sodium borohydride with CO₂ and NH₃ (equation 5), as well as the reaction of sodium borohydride with (NH₄)₂CO₃ (equation 6). The reaction presented in equation 6 fails to provide satisfactory yields in large scale applications.

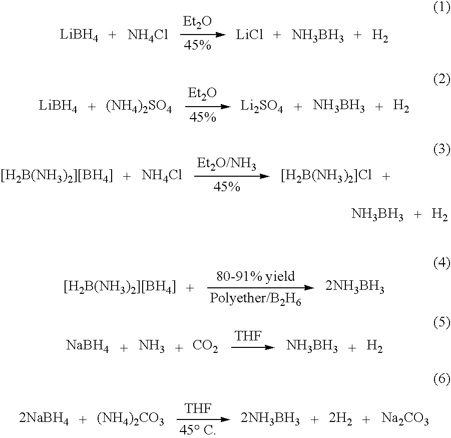

Diborane is a versatile reagent with a wide variety of applications in organic and inorganic syntheses. It is normally stored, transported and used as a Lewis-base complex, such as borane-methyl sulfide (BMS) or borane-THF (BTHF). While the former is available as a 10 M neat material, the latter is available as a 2.5 M solution under normal pressures. However, borane-methyl sulfide is less preferred due to its stench and borane-THF loses its hydride activity over a period when stored at room temperature. Hence a variety of borane-trialkylamine complexes have been recently introduced. These borane-trialkylamine complexes are currently prepared by generating borane from sodium borohydride and complexing with amines, or by Lewis base exchange of BMS and BTHF with the corresponding amines.

Despite the availability of these procedures, an efficient and cost effective process is still desirable to decrease the current cost of ammonia borane, which is disproportional to the starting material costs. It is therefore an object of the present invention to provide an efficient and cost effective process to prepare ammonia borane.

To make ammonia borane a potential source for portable applications or for stationary systems, improvement to the reaction controls are required. Currently ammonia borane on pyrolysis liberates hydrogen in sequence of reactions between 100° C. to 400° C. Depending on the conditions, several species have been previously observed. Particularly, formation of volatile borazine is found to be detrimental to the fuel cell membrane. Alcoholysis, particularly methanolysis and hydrolysis of the amine boranes, is also reported to produce hydrogen. Although all these methods are used for hydrogen generation, there is no report for the recycling of generated boron species back to ammonia borane. Different kinds of boron species are produced during the pyrolysis, methanolysis or hydrolysis of the ammonia borane or amine boranes. These generated boron species are going to be a major load on the environment if they are not recycled back to ammonia borane. It is therefore another object of the present invention to provide a procedure for regenerating ammonia borane.

Borazine is currently prepared from sodium borohydride and ammonium sulfate in tetraglyme or diglyme at 140-160° C. by removal under the dynamic vacuum (2-5 torr) and collecting in multiple traps maintained at −45° C., −78° C. and −196° C. Alternatively, ammonia borane is used and borazine is collected at the above temperatures. These procedures are tedious and need special reaction setup with multiple low temperature traps under dynamic high vacuum. It is therefore yet another object of the present invention to provide a procedure for the synthesis of borazine under mild conditions.

### BRIEF SUMMARY OF THE INVENTION

According to one embodiment of the present invention, a process for preparing ammonia borane comprises reacting a metal borohydride with an ammonia salt under an ambient condition. Greater than about 50% of the metal borohydride is converted to ammonia borane.

According to another embodiment of the present invention, a process for generating hydrogen comprises reacting ammonia borane with a solvent in the presence of a metal catalyst at an ambient temperature. Substantially all 3 equivalents of hydrogen are evolved from ammonia borane in less than about 24 hours.

According to yet another embodiment of the present invention, a process for generating hydrogen comprises reacting borazine with a solvent in the presence of a metal catalyst at an ambient temperature. Substantially all 3 equivalents of hydrogen are evolved from borazine in less than about 24 hours.

According to further yet another embodiment of the present invention, a process for regenerating ammonia borane from ammonium tetramethoxyborate comprises reacting ammonium tetramethoxyborate with an ammonium salt and a metal hydride to afford ammonia borane.

### BRIEF DESCRIPTION OF THE FIGURES

FIG. 1 illustrates the ORTEP diagram of ammonium tetramethoxyborate at 50% probability.

### DESCRIPTION OF THE INVENTION

According to one embodiment of the present invention, a process for preparing ammonia borane comprises reacting a metal borohydride with an ammonia salt under an ambient condition. Preferably, greater than about 50% of the metal borohydride is converted to ammonia borane. More preferably, greater than 80% of the metal borohydride is converted to ammonia borane. Even more preferably, about 80%-96% of the metal borohydride is converted to ammonia borane.

Preferably, the reaction is carried out at a temperature of about 20° C. to about 50° C. More preferably, the reaction is carried out at a temperature of about room temperature to about 40° C.

Preferably, the metal borohydride is lithium borohydride or sodium borohydride. More preferably, the metal borohydride is sodium borohydride. The ammonia salt can be ammonium sulfate, ammonium chloride, ammonium fluoride, ammonium carbonate, ammonium nitrate, ammonium acetate, or ammonium formate. Preferably, the ammonia salt is ammonium sulfate. More preferably, the ammonia salt is powdered ammonium sulfate.

Preferably, the reaction is carried out in THF. Preferably, the ammonia salt is powdered ammonium sulfate and the metal borohydride is sodium borohydride. The molar ratio of the sodium borohydride to the ammonium sulfate is preferably about 1:0.5 to about 1:1.5, more preferably about 1:0.6 to about 1:1, even more preferably about 1:0.75 to about 1:1, and further even more preferably about 1:1.

Preferably, the reaction is carried out in dioxane. Preferably, the ammonia salt is ammonium formate and the metal borohydride is sodium borohydride. The molar ratio of the sodium borohydride to the ammonium formate is preferably about 1:1 to about 1:2, more preferably about 1:1.5.

Preferably, the reaction is carried out for a time period of about 0.5 hours to about 10 hours. More preferably, the reaction is carried out for a time period of about 1 hours to about 4 hours.

Preferably, the reaction is carried out in a solvent. The solvent can be THF or dioxane. Preferably, some of the THF solvent is recovered and re-used. More preferably, about 90% of the THF solvent is recovered and re-used. Preferably, some of the dioxane solvent is recovered and re-used. More preferably, about 90% of the dioxane solvent is recovered and re-used.

Preferably, the reaction is carried out in air.

According to another embodiment of the present invention, a process for generating hydrogen comprises reacting ammonia borane with a solvent in the presence of a metal catalyst at an ambient temperature. Alternatively, borazine is used instead of ammonia borane. Substantially all 3 equivalents of hydrogen are evolved from ammonia borane preferably in less than about 24 hours, more preferably in less than about 2 hours, even more preferably in less than about 1 hour, further even more preferably in less than about 30 minutes, and yet even more preferably in less than about 10 minutes.

Preferably, the solvent can be water or an alcohol. The solvent can be methanol, ethanol, n-propanol, n-butanol, isopropanol or t-butanol. Preferably, the solvent is methanol.

The metal catalyst can be a transition metal catalyst. Preferably, the metal catalyst is RuCl₃, RhCl₃, CoCl₂, NiCl₂, PdCl₂, CuCl₂, Raney Ni or Pd—C. More preferably, the metal catalyst is RuCl₃ or PdCl₂. The weight percentage of the metal catalyst is preferably from about 0.01% to about 10%, more preferably from about 0.05% to about 5%.

According to yet another embodiment of the present invention, a process for regenerating ammonia borane from ammonium tetramethoxyborate comprises reacting ammonium tetramethoxyborate with an ammonium salt and a metal hydride to afford ammonia borane. Preferably greater than about 50% of the ammonium tetramethoxyborate is converted to ammonia borane. More preferably, greater than about 65% of the ammonium tetramethoxyborate is converted to ammonia borane. Even more preferably, greater than about 80% of the ammonium tetramethoxyborate is converted to ammonia borane.

The metal hydride can be lithium hydride, lithium aluminum hydride or sodium aluminum hydride. Preferably, the metal hydride is lithium aluminum hydride.

The ammonia salt can be ammonium sulfate, ammonium chloride, ammonium fluoride, ammonium carbonate, ammonium nitrate, ammonium acetate, or ammonium formate. Preferably, the ammonia salt is ammonium chloride.

Preferably, the reaction is carried out at a temperature of about 0° C. to about 50° C. More preferably, the reaction is carried out at a temperature of about 0° C. to about room temperature.

Preferably, the metal hydride is cooled before the reaction. The metal hydride is cooled preferably to 0° C., and more preferably to −78° C.

The reaction can be carried out at an atmospheric pressure. Alternatively, the reaction can be carried out in a sealed reactor.

Preferably, the reaction mixture is stirred at room temperature for about 3 hours to about 10 hours. More preferably, the reaction mixture is stirred at room temperature for about 8-10 hours. The reaction is carried out preferably in a solvent, and more preferably in THF.

Preferably, the reaction mixture is concentrated to form a crude ammonia borane. Preferably, the crude ammonia borane is extracted to form a purified ammonia borane. More preferably, the crude ammonia borane is extracted using diethyl ether. Preferably, the extraction is carried out at 0° C. for about 1 to about 2 hours.

### EXAMPLES

### Example 1

### Preparation of Borane-Amines

Preparation of borazane from LiBH₄ and reactions of LiBH₄ with ammonium salts (for example, ammonium chloride and ammonium sulfate) in various solvents at different temperatures are examined. Increased yields of borane-ammonia are achieved by conducting the reactions of lithium borohydride with ammonium salts, such as ammonium chloride and ammonium sulfate, in THF at ambient temperatures (40° C.). Ammonium sulfate reacts faster than ammonium chloride and carbonate. Brisk filtration, followed by concentration, generates >95% chemically pure ammonia-borane in >90% yields. The purity of the material is determined by ¹¹B NMR spectroscopy, elemental analysis and hydrolysis reaction.

The synthesis of borane-ammonia starts with trimethyl borate. The process of the present invention is based on the preparation of lithium borohydride by treating methyl borate with lithium hydride and aluminum chloride. The process involves the synthesis of borane-ammonia in one-pot from trimethyl borate by reacting lithium aluminum hydride with ammonium salts, such as ammonium chloride, ammonium carbonate, ammonium acetate, ammonium carbonate, and the like. The process also involves the synthesis of borane-ammonia in one-pot from trimethyl borate by reacting lithium hydride and aluminum chloride with ammonium salts, such as ammonium chloride, ammonium carbonate, ammonium acetate, ammonium carbonate, and the like.

Procedures are developed to prepare borane-trialkylamine complexes from trimethyl borate, by treating lithium or sodium hydride with aluminum chloride and trialkyl amines, where the amines are triethylamine, 2,6-lutidine, 2,4,6-collidine, N,N-diisopropylethylamine, N,N-dimethylaminopyridine, DABCO, and N-methylmorpholine.

Borane-amine complex is also synthesized by treating a borate complex with lithium or sodium hydride with aluminum chloride, and an amine. An example of this process is the reaction of lithium bis(ethyleneglycolate)borate and ethylene glycol, lithium hydride, aluminum chloride and triethylamine

Borane-triphenylphosphine also has been synthesized by treating methyl borate with lithium or sodium hydride, aluminum chloride, and triphenylphosphine.

Experimental

Improved Procedure for the Preparation of Borane-Ammonia

(i) From Lithium Borohydride

Under nitrogen, lithium borohydride (0.110 g, 0.0045 mole) and ammonium sulfate (0.606 g, 0.0045 moles) are added to a round bottom flask. Dry THF (30 ml) is transferred to the reaction mixture and stirred at 40° C. for 7 hours. The reaction is monitored by ¹¹B NMR spectroscopy. The reaction mixture is concentrated under vacuum to remove the solvent. The obtained white powder is stirred in dry ether (30 ml) at 0-5° C. for 30 minutes, filtered, and the filtrate is concentrated under vacuum to obtain ammonia-borane in >90% yield as a white solid. The estimated purity of ammonia-borane by alcoholysis, wherein palladium chloride was used as catalyst, is >90%.

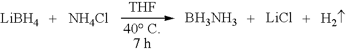

(ii) From Trimethyl Borate, Lithium Aluminum Hydride and Ammonium Chloride

To lithium aluminum hydride (0.383 g, 0.0096 moles) and ammonium chloride (0.770 g, 0.0144 moles) in tetrahydrofuran solvent (30 ml), trimethyl borate (0.5 g, 0.0048 moles) is added dropwise at room temperature and stirred for 30 hours under nitrogen atmosphere. The ¹¹B NMR shows the formation of BH₃NH₃ and 10% LiBH₄. The solvent is removed under reduced pressure, cooled to 0° C. and extracted with dry ether. The ether layer is transferred to another round bottom flask with canula and the solvent is removed under reduced pressure to give ammonia-borane (0.156 g). The compound purity is analyzed by alcoholysis with methanol and catalytic palladium chloride. The obtained yield based on alcoholysis is 46.58%.

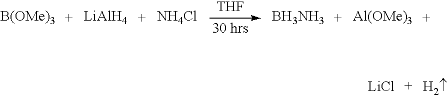

Preparation of Ammonia Borane with Trimethyl Borate, Lithium Hydride, Aluminum Chloride and Ammonium Chloride

To lithium hydride (0.170 g, 0.02016 moles) and ammonium chloride (0.513 g, 0.0096 moles) in tetrahydrofuran solvent (30 ml), trimethyl borate (0.5 g, 0.0048 moles) is added dropwise at room temperature under nitrogen atmosphere. The aluminum chloride (0.768 g, 0.00576 moles) in tetrahydrofuran (8 ml) is added dropwise and stirred for 8 hours at room temperature. The ¹¹B NMR shows the formation of BH₃NH₃. The solvent is removed under reduced pressure and the reaction mixture is cooled to −78° C. and extracted with dry ether. The ether layer is transferred to another round bottom flask with canula and the solvent is removed under reduced pressure to give ammonia-borane (0.118 g). The compound purity is analyzed by alcoholysis with methanol and catalytic palladium chloride. The obtained yield based on alcoholysis is 43.47%.

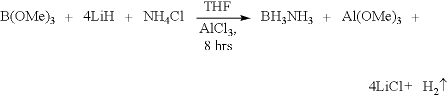

Preparation of Ammonia Borane with Trimethyl Borate, Lithium Aluminum Hydride and Ammonium Carbonate

To lithium aluminum hydride (0.383 g, 0.0096 moles) and ammonium carbonate (1.387 g, 0.0144 moles) in tetrahydrofuran solvent (30 ml), trimethyl borate (0.5 g, 0.0048 moles) is added dropwise under nitrogen atmosphere and stirred at room temperature for 30 hours. The ¹¹B NMR shows the formation of BH₃NH₃ and 20% LiBH₄. The solvent is removed under reduced pressure and the reaction mass is cooled to −78° C. and extracted with dry ether. The ether layer is transferred to another round bottom flask with canula and the solvent is removed under reduced pressure to give ammonia-borane (0.177 g). The compound purity is analyzed by alcoholysis with methanol and catalytic palladium chloride. The obtained yield based on alcoholysis is 62.73%.

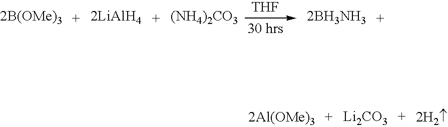

Preparation of Ammonia Borane with Trimethyl Borate, Lithium Aluminum Hydride and Ammonium Sulfate

To lithium aluminum hydride (0.384 g, 0.0096 moles) and ammonium sulfate (1.91 g, 0.0144 moles) in tetrahydrofuran solvent (30 ml), trimethyl borate (0.5 g, 0.0048 moles) is added dropwise under nitrogen atmosphere and stirred at room temperature for 24 hours. The ¹¹B NMR shows the formation of BH₃NH₃ and 25% LiBH₄. The solvent is removed under reduced pressure and the reaction mass is cooled to −78° C. and extracted with dry ether. The ether layer is transferred to another round bottom flask with canula and the solvent is removed under reduced pressure to give ammonia-borane (0.73 g). The compound purity is analyzed by alcoholysis with methanol and catalytic palladium chloride. The obtained yield based on alcoholysis is 40.37%.

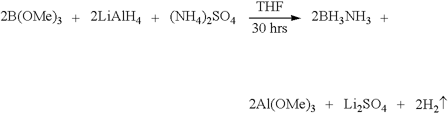

Preparation of Ammonia Borane with Trimethyl Borate, Lithium Hydride, Aluminum Chloride and Ammonium Sulfate

To lithium hydride (0.170 g, 0.02016 moles) and ammonium sulfate (1.27 g, 0.0096 moles), trimethyl borate (0.5 g, 0.0048 moles) is added dropwise under nitrogen atmosphere. The aluminum chloride (0.768 g, 0.00576 moles) in tetrahydrofuran (8 ml) is added dropwise and stirred at room temperature for 24 hours. The ¹¹B NMR shows the formation of BH₃NH₃. The solvent is removed under reduced pressure and the reaction mass is cooled to −78° C. and extracted with dry ether. The ether layer is transferred to another round bottom flask with canula and the solvent is removed under reduced pressure to give ammonia-borane (0.350 g). The compound purity is analyzed by alcoholysis with methanol and catalytic palladium chloride. The obtained yield based on alcoholysis is 53.41%.

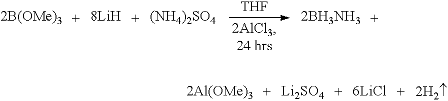

Preparation of Ammonia Borane with Trimethyl Borate, Lithium Hydride, Aluminum Chloride and Ammonium Acetate

To lithium hydride (0.170 g, 0.02016 moles) and ammonium acetate (1.27 g, 0.0096 moles) in tetrahydrofuran solvent (30 ml), trimethyl borate (0.5 g, 0.0048 moles) is added dropwise under nitrogen atmosphere. The aluminum chloride (0.768 g, 0.00576 moles) in tetrahydrofuran (8 ml) is added dropwise and stirred at room temperature for 24 hours. The ¹¹B NMR shows the formation of BH₃NH₃. The solvent is removed under reduced pressure and the reaction mass is cooled to −78° C. and extracted with dry ether. The ether layer is transferred to another round bottom flask with canula and the solvent is removed under reduced pressure to give ammonia-borane (0.167 g). The compound purity is analyzed by alcoholysis with methanol and catalytic palladium chloride. The obtained yield based on alcoholysis is 41.92%.

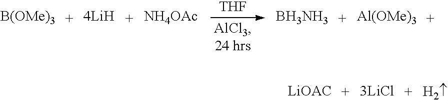

Preparation of Ammonia Borane with Trimethyl Borate, Lithium Aluminum Hydride and Ammonium Nitrate

To lithium aluminum hydride (0.384 g, 0.0096 moles) and ammonium nitrate (1.15 g, 0.0144 moles) in tetrahydrofuran solvent (30 ml), trimethyl borate (0.5 g, 0.0048 moles) is added dropwise under nitrogen atmosphere and stirred at room temperature for 24 hours. The ¹¹B NMR shows the formation of BH₃NH₃. The solvent is removed under reduced pressure and the reaction mass is cooled to −78° C. and extracted with dry ether. The ether layer is transferred to another round bottom flask with canula and the solvent is removed under reduced pressure to give ammonia-borane (0.181 g). The compound purity is analyzed by alcoholysis with methanol and catalytic palladium chloride. The obtained yield based on alcoholysis is 46.58%.

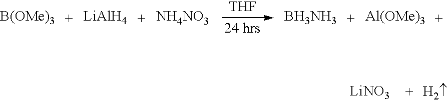

Preparation of Borane Ammonia of >90% Purity from Trimethyl Borate

All of the above procedures yielded ammonia-borane. However, the purity is not satisfactory. Borazane with >90% chemical purity is prepared by varying the addition protocol. Thus mixing of NH₄Cl and trimethyl borate, followed by addition of LAH provided borazane in high purity in much shorter reaction period, within 2 hour as compared to 16-30 hour using the protocols described above.

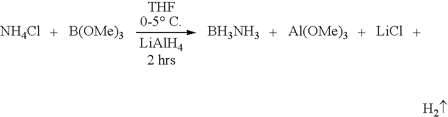

To ammonium chloride (0.518 g, 0.0096 moles) in dry tetrahydrofuran (6 ml), trimethyl borate (0.5 g, 0.0048 moles) is added under nitrogen atmosphere and the mixture is cooled to 0-5° C. Under vigorous stirring, lithium aluminum hydride (0.287 g, 0.0072 moles) in tetrahydrofuran (6 ml) is added dropwise over a period of one hour at the same temperature. The reaction mixture is brought to room temperature and stirred for another 2 hours. The ¹¹B NMR shows the formation of borane-ammonia (quartet at δ 21-22 ppm). The solvent is removed under reduced pressure. The obtained free flowing powder is cooled to 0-5° C. and extracted with dry cold ether (30 ml) and stirred for one hour. The cold ether layer is centrifuged, the supernatant transferred to another round bottom flask using a cannula and the solvent removed under vacuum to provide borane-ammonia (0.081 g) as a white crystalline solid. The compound purity is analyzed by alcoholysis with methanol and catalytic palladium chloride. The obtained yield based on alcoholysis is 87% with 95% purity.

Preparation of Borane Triethylamine Complex from Trimethyl Borate, Lithium Hydride and Triethyl Amine:

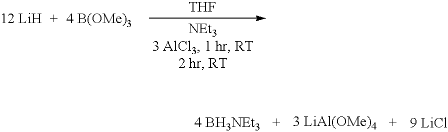

To lithium hydride (0.182 g, 0.0216 moles) and triethyl amine (2 ml) in tetrahydrofuran solvent (10 ml), trimethyl borate (0.5 g, 0.0048 moles) is added under nitrogen atmosphere at room temperature and stirred for one hour. The reaction mixture monitored by ¹¹B NMR and shows a singlet at δ+3. The aluminum chloride (0.960 g, 0.0072 moles) in tetrahydrofuran (8 ml) is added dropwise over a period of one hour and stirring continued for another 2 hours. The ¹¹B NMR shows the formation of BH₃NEt₃. The solvent is removed under reduced pressure and the reaction mixture is extracted with dry petroleum ether. The solvent is filtered using sintered funnel under vacuum; the solvent is removed under reduced pressure to give the borane-triethylamine complex (0.496 g) in 90% yield.

Preparation of Borane 2,6-lutidine Complex with Trimethyl Borate, Lithium Hydride and 2,6-lutidine

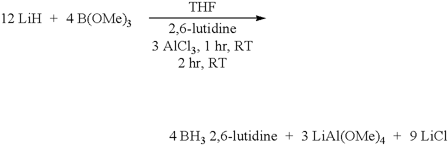

To lithium hydride (0.182 g, 0.0216 moles) and 2,6-lutidine (2 ml) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of borane 2,6-lutidine. The solvent is removed under reduced pressure and the reaction mixture is extracted with dry dichloromethane. The solvent is filtered using sintered funnel under vacuum and the solvent is removed under reduced pressure to give the borane 2,6-lutidine complex (0.365 g) in 62.7% yield.

Preparation of Borane 2,4,6-collidine Complex with Trimethyl Borate, Lithium Hydride and 2,4,6-collidine

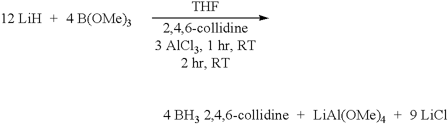

To lithium hydride (0.182 g, 0.0216 moles) and 2,4,6-collidine (0.581 g) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of borane 2,4,6-collidine. The solvent is removed under reduced pressure and the reaction mass is extracted with dry dichloromethane. The solvent is filtered using sintered funnel under vacuum, and the solvent is removed under reduced pressure to give the borane 2,4,6-collidine complex (0.580 g) in 90% yield.

Preparation of Borane N,N-diisopropylethyl Amine Complex with Trimethyl Borate, Lithium Hydride and N,N-diisopropyl Ethyl Amine N,N-diisopropyl Ethyl Amine

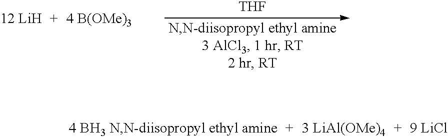

To lithium hydride (0.182 g, 0.0216 moles) and N,N-diisopropyl ethyl amine (2 ml) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of borane N,N-diisopropyl ethyl amine. The solvent is removed under reduced pressure and the reaction mass is extracted with dry dichloromethane. The solvent is filtered using sintered funnel under vacuum, and the solvent is removed under reduced pressure to give the borane N,N-diisopropyl ethyl amine complex (0.540 g) in 78.7% yield.

Preparation of Borane 4-N,N-dimethyl Amino Pyridine Complex with Trimethyl Borate, Lithium Hydride and N,N-dimethyl Amino Pyridine

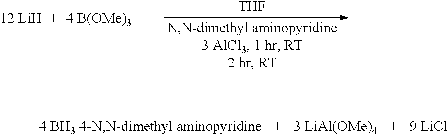

To lithium hydride (0.182 g, 0.0216 moles) and N,N-dimethyl amino pyridine (DMAP) (0.586 g) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of borane N,N-dimethyl amino pyridine. The solvent is removed under reduced pressure and the reaction mass is extracted with dry dichloromethane under stirring. The solvent is filtered using sintered funnel under vacuum, and the solvent is removed under reduced pressure to give borane N,N-dimethyl amino pyridine (0.588 g) in 90.7% yield.

Preparation of Borane DABCO Complex with Trimethyl Borate, Lithium Hydride and DABCO

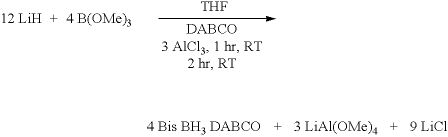

To lithium hydride (0.182 g, 0.0216 moles) and DABCO (0.269 g) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of borane DABCO. The solvent is removed under reduced pressure and the reaction mass is extracted with dry dichloromethane. The solvent is filtered using sintered funnel under vacuum; the solvent is evaporated under reduced pressure to give the bis borane DABCO (0.380 g). The melting point (MP) is observed as >300° C.

Preparation of Borane Triphenyl Complex with Trimethyl Borate, Lithium Hydride and PPh₃

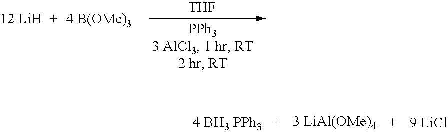

To lithium hydride (0.182 g, 0.0216 moles) and triphenylphosphine (0.1.2 g) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of BH₃ PPh₃. The solvent is removed under reduced pressure and the reaction mass is extracted with dry dichloromethane. The solvent is filtered using sintered funnel under vacuum, and the solvent is evaporated under reduced pressure to give the borane PPh₃ (1.24 g) in 93.9% yield.

Preparation of Borane-NMO Complex with Trimethyl Borate, Lithium Hydride and N-methyl Morpholine

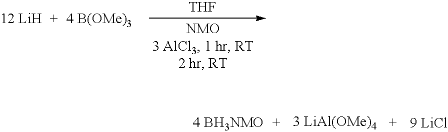

To lithium hydride (0.182 g, 0.0216 moles) and N-methyl morpholine (2 ml) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of borane N-methyl morpholine. The solvent is removed under reduced pressure and the reaction mass is extracted with dry dichloromethane. The solvent is filtered using sintered funnel under vacuum; the solvent is removed under reduced pressure to give the N-methyl morpholine (0.164 g) in 30% yield.

Preparation of Borane Triethylamine Complex with Trimethyl Borate Sodium Hydride and Triethyl Amine

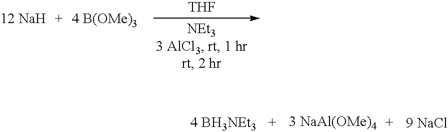

To sodium hydride (0.518 g, 0.0216 moles) and triethyl amine (2 ml) in tetrahydrofuran solvent (10 ml), trimethyl borate (0.5 g, 0.0048 moles) is added under nitrogen atmosphere at room temperature and stirred for one hour. The aluminum chloride (0.960 g, 0.0072 moles) in tetrahydrofuran (8 ml) is added dropwise over a period of one hour and stirring continuously for another 2 hours. The ¹¹B NMR shows the formation of BH₃NEt₃. The solvent is removed under reduced pressure and the reaction mass is extracted with dry petroleum ether. The solvent is filtered using sintered funnel under vacuum; the solvent is removed under reduced pressure to give the borane triethylamine complex (0.455 g) in 82.43% yield.

Preparation of Borane Morpholine Complex with Trimethyl Borate and Sodium Hydride

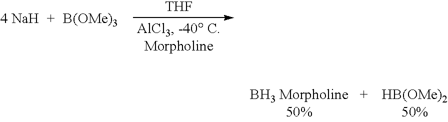

To sodium hydride (0.485 g, 0.02 moles) and morpholine (0.42 ml) in tetrahydrofuran (10 ml), trimethyl borate (0.5 g, 0.0048 moles) is added under nitrogen atmosphere and stirred at −40° C. for one hour. The aluminum chloride (0.768 g, 0.0057 moles) in tetrahydrofuran (8 ml) is added dropwise over a period of one hour and stirring continuously for another 2 hours at −40° C. The ¹¹B NMR shows the formation of borane morpholine in 50% and 50% HB(OMe)₂.

Preparation of Borane Triethylamine Complex with Lithium Bis(ethyleneglycolate)borate Complex, Lithium Hydride, Aluminum Chloride and Triethyl Amine

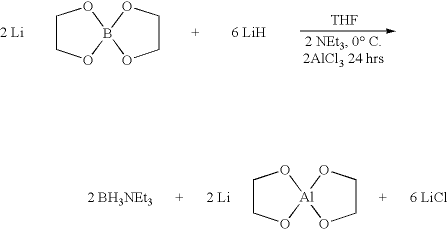

Lithium bis(ethyleneglycolate)borate complex (0.5 g, 0.0036 moles), lithium hydride (0.137 g, 0.0163 moles) and triethyl amine (2 ml) in tetrahydrofuran (20 ml) solvent are stirred at 0° C. under nitrogen atmosphere for one hour. The aluminum chloride (0.724 g, 0.0054 moles) in THF (8 ml) is added dropwise over a period of one hour at 0° C. The reaction mixture is stirred for another 24 hours. The ¹¹B NMR shows the formation of BH₃NEt₃. The solvent is removed under reduced pressure and extracted with petroleum ether, and the ether layer is evaporated under reduced pressure to give the BH₃NEt₃ (0.2 g) in 48.3% yield.

### Example 2

Improved Procedure for the Preparation of Borane-Ammonia in THF

A further improved procedure is achieved for the synthesis of ammonia borane from sodium borohydride under ambient conditions in THF in a 97% yield and >98% purity.

In Example 1, the synthesis of ammonia borane uses lithium borohydride. However, lithium borohydride is generally prepared from sodium borohydride and is relatively expensive. An efficient and cost effective procedure is developed for the preparation of ammonia borane using sodium borohydride and ammonium salts in tetrahydrofuran at ambient temperature ranging from room temperature (RT) to 40° C. (0.165 M concentration with respect to sodium borohydride). Most of the solvent tetrahydrofuran (˜90%) is recovered and re-used. It should be noted that all of the operations are carried out in air, and thus inert atmosphere is not required.

Different ammonium salts, such as ammonium sulfate, ammonium formate, ammonium carbonate, ammonium nitrate, ammonium chloride, ammonium fluoride, and ammonium acetate, have been examined. It is observed that ammonium sulfate gives the best results. Particularly, powdered ammonium sulfate is found to be superior since it shortens the reaction time and decreases the molar ratio of ammonium sulfate required with respect to sodium borohydride.

The molar ratio of sodium borohydride to ammonium sulfate ranging from about 1:0.6 to about 1:1 is examined. Theoretically, 0.5 molar ratio of ammonium sulfate should be sufficient for the preparation of ammonia borane from sodium borohydride. To achieve optimal yields, however, it is observed that a molar ratio less than 0.75 of ammonium sulfate leads to prolonged reaction time and to the formation of 5-10% of the impurity due to decomposition of ammonia borane. It is also observed that ammonia borane is obtained in high yield and high purity when the ratio of sodium borohydride to ammonium sulfate is about 1:1. The purity of the material is determined by ¹¹B NMR spectroscopy, elemental analysis and hydrolysis or alcoholysis reaction wherein the evolved hydrogen is measured by gas burette.

Experimental

Large-Scale Preparation of Ammonia-Borane Using Sodium Borohydride and Ammonium Sulfate in THF

Sodium borohydride (25 g, 0.66 mol) and ammonium sulfate (87 g, 0.66 mol) are added to a round bottom flask. THF (4 L) is transferred into the reaction mixture, which is stirred at 40° C. for 2 hours. The reaction is monitored by ¹¹B NMR spectroscopy. The reaction mixture is then cooled to RT and filtered. The filtrate is concentrated under vacuum to afford ammonia-borane (19.7 g) in 97% yield with 98% purity, based on hydride analysis.

Preparation of Ammonia-Borane Using Sodium Borohydride and Ammonium Nitrate in THF

Sodium borohydride (0.100 g, 0.0026 mol) and ammonium nitrate (0.416 g, 0.0052 mol) are added to a round bottom flask. THF (16 ml) is transferred into the reaction mixture, which is stirred at RT for 3 hours. The reaction is monitored by ¹¹B NMR spectroscopy. The reaction mixture is then cooled to 0-5° C. and filtered. The filtrate is concentrated under vacuum to afford ammonia-borane in 83% yield as a white solid with 82% purity.

Preparation of Ammonia-Borane Using Sodium Borohydride and Ammonium Acetate in THF

Sodium borohydride (0.100 g, 0.0026 mol) and ammonium acetate (0.407 g, 0.0052 mol) are added to a round bottom flask. THF (15 ml) is transferred into the reaction mixture, which is stirred at 40° C. for 4 hours. The reaction is monitored by ¹¹B NMR spectroscopy. The reaction mixture is then cooled to 0-5° C. and filtered. The filtrate is concentrated under vacuum to afford ammonia-borane in 75% yield as a white solid.

Preparation of Ammonia-Borane Using Sodium Borohydride and Ammonium Carbonate in THF

Sodium borohydride (0.100 g, 0.0026 mol) and ammonium carbonate (0.249 g, 0.0026 mol) are added to a round bottom flask. THF (20 ml) is transferred into the reaction mixture, which is stirred at RT for 4 hours. The reaction is monitored by ¹¹B NMR spectroscopy. The reaction mixture is cooled to 0-5° C. and filtered under nitrogen atmosphere. The filtrate is concentrated under vacuum to afford ammonia-borane in 82% yield as a white solid with 95% purity.

Preparation of Ammonia-Borane Using Sodium Borohydride and Ammonium Formate in THF

Sodium borohydride (0.1 g, 2.643 mmol) and ammonium formate (0.216 g, 3.43 mol) are added to a round bottom flask. THF (16 ml) is transferred into the reaction mixture, which is stirred at 40° C. for 1 hour. The reaction is monitored by ¹¹B NMR spectroscopy. The reaction mixture is then cooled to room temperature and filtered. The filtrate is concentrated under vacuum to obtain ammonia-borane (0.77 g) in 95% yield with >98% purity, based on hydride analysis.

Preparation of Ammonia-Borane Using Sodium Borohydride and Ammonium Fluoride in THF

Sodium borohydride (0.100 g, 0.0026 mol) and ammonium fluoride (0.195 g, 0.0052 mol) are added to a round bottom flask. THF (20 ml) is transferred into the reaction mixture, which is stirred at RT for 1.5 hours. The reaction is monitored by ¹¹B NMR spectroscopy. The reaction mixture is then cooled to 0-5° C. and filtered. The filtrate is concentrated under vacuum to afford ammonia-borane in 84% yield as a white solid with 95% purity.

### Example 3

### Improved Procedure for the Preparation of Borane-Ammonia in Dioxane

In Example 2, an improved synthesis of ammonia borane is achieved in THF. The dilution of the reaction medium, however, remains an obstacle for preparation of ammonia borane in bulk scale. To increase the reaction concentration, a series of solvents are examined and it is observed that dioxane gives the best results. Since dioxane is the solvent of choice, different ammonium salts, such as ammonium sulfate, ammonium carbonate, ammonium nitrate, ammonium chloride, ammonium fluoride, ammonium formate and ammonium acetate, are then examined. It is observed that ammonium formate gives the best results. Thus an efficient and cost effective preparation of ammonia borane in 95% yield and 98% purity is achieved using sodium borohydride and ammonium formate in anhydrous dioxane (1 M concentration with respect to sodium borohydride) at ambient temperature ranging from room temperature (RT) to 40° C. Most of the dioxane (>90%) is recovered and re-used.

The molar ratio of sodium borohydride to ammonium formate ranging from 1:1 to 1:2 is examined. It is observed that ammonia borane is obtained in high yield and high purity when the ratio of sodium borohydride to ammonium sulfate is about 1:1.5. The purity of the material is determined by ¹¹B NMR spectroscopy and hydrolysis or alcoholysis reaction wherein the evolved hydrogen is measured by analytical gas burette.

Experimental

Large-Scale Preparation of Ammonia-Borane Using Sodium Borohydride and Ammonium Formate in Dioxane

Sodium borohydride (379 g, 10 mol) and ammonium formate (945 g, 15 mol) are added under nitrogen atmosphere to a 20 L three neck round-bottom flask fitted with a overhead stirrer, a condenser and a stopper. The top of the condenser is directed through an oil bubbler into an exhaust hood outlet. Anhydrous dioxane (10 L) is transferred into the reaction mixture, which is stirred at 40° C. for 12 hours. The reaction is monitored by ¹¹B NMR spectroscopy. The reaction mixture is then cooled to room temperature and filtered through a celite bed and the filtrate is concentrated. The solid residue is stirred in THF, filtered and the filtrate is concentrated to obtain ammonia borane. Both crops of ammonia borane are combined and dried under high vacuum. The yield of ammonia borane is 95% with >98% purity, based on hydride analysis and ¹¹B NMR.

Preparation of Ammonia-Borane Using Sodium Borohydride and Ammonium Fluoride in Dioxane

Sodium borohydride (0.1 g, 2.64 mmol) and ammonium fluoride (0.195 g, 5.28 mmol) are added to a round bottom flask. Dioxane (5 mL) is transferred into the reaction mixture, which is stirred at 25° C. for 3 hours. The reaction is monitored by ¹¹B NMR spectroscopy, which shows a 1.5% impurity peak at δ 0 ppm.

Preparation of Ammonia-Borane Using Sodium Borohydride and Ammonium Acetate in Dioxane

Sodium borohydride (0.1 g, 2.64 mmol) and ammonium acetate (0.408 g, 5.28 mmol) are added to a round bottom flask. Dioxane (5 mL) is transferred into the reaction mixture, which is stirred at 25° C. for 3 hours. The reaction is monitored by ¹¹B NMR spectroscopy, which shows impurity peaks at δ−7 ppm and at −14 ppm.

Preparation of Ammonia-Borane Using Sodium Borohydride and Ammonium Chloride in Dioxane

Sodium borohydride (0.1 g, 2.64 mmol) and ammonium chloride (0.285 g, 5.28 mmol) are added to a round bottom flask. Dioxane (5 mL) is transferred into the reaction mixture, which is stirred at 25° C. The reaction is monitored by ¹¹B NMR spectroscopy, which shows that the reaction is incomplete even after 12 hours (80% unreacted borohydride).

Preparation of Ammonia-Borane Using Sodium Borohydride and Ammonium Nitrate in Dioxane

Sodium borohydride (0.1 g, 2.64 mmol) and ammonium nitrate (0.422 g, 5.28 mmol) are added to a round bottom flask Dioxane (5 mL) is transferred into the reaction mixture, which is stirred at 25° C. The reaction is monitored by ¹¹B NMR spectroscopy, which shows impurity peaks at δ−7 ppm (1%) and at −14 ppm (3.6%).

Preparation of Ammonia-Borane Using Sodium Borohydride and Carbonate in Dioxane

Sodium borohydride (0.1 g, 2.64 mmol) and ammonium carbonate (0.422 g, 2.64 mmol) are added to a round bottom flask. Dioxane (5 mL) is transferred into the reaction mixture, which is stirred at 25° C. for 2 hours. The reaction is monitored by ¹¹B NMR spectroscopy, which shows completion of the reaction. During the reaction, the reaction mixture becomes so viscous that it can not be stirred at the end of the reaction. The reaction mixture is diluted with 5 ml dioxane and filtered. The filtrate is concentrated to afford ammonia borane in a 75% yield and 96% purity.

### Example 4

### Improved Procedure for the Synthesis of Borazine

It is observed that 10 mol % AlCl₃ or MgCl₂ or transition metal catalyst such as ruthenium chloride or palladium chloride when used as the catalyst in the reaction facilitates the reaction at lower temperature. Herein, an improved procedure is achieved for the synthesis of borazine from sodium borohydride and ammonium salts under ambient conditions in a 60% yield and high purity.

Different ammonium salts have been examined, such as ammonium sulfate, ammonium carbonate, ammonium nitrate, ammonium chloride, ammonium fluoride, and ammonium acetate. It is observed that ammonium sulfate gives the best results. Particularly, powdered ammonium sulfate is found to be superior since it shortens the reaction time and decreases molar ratio of ammonium sulfate required with respect to sodium borohydride.

Experimental

Preparation of Borazine Using Sodium Borohydride and Ammonium Sulfate

Sodium borohydride (25 g, 0.66 mol) and ammonium sulfate (60 g, 0.462 mol) are added to a 2 L single neck round bottom flask and the flask is sealed with a rubber septa. The reaction flask is connected via cannula to a trap that is cooled at −50° C. Diglyme (100 ml) is transferred to the reaction mixture. AlCl₃ (10 mol %) is added and the reaction mixture is stirred and gradually heated to 90° C. and maintained at the same temperature for 4 hours. Following the reaction, the borazine that have been retained in the trap is further purified by vacuum distillation in a 60% yield.

Preparation of Borazine Using Ammonia Borane

Ammonia borane (20 g) is added to a 1 L single neck round bottom flask and the flask is sealed with a rubber septa. The reaction flask is connected via cannula to a trap that is cooled at −50° C. Diglyme (50 ml) is transferred to the reaction mixture. AlCl₃ (10 mol %) is added and the reaction mixture is stirred and gradually heated to 90° C. and maintained at the same temperature for 4 hours. Following the reaction, the borazine that have been retained in the trap is further purified by vacuum distillation in a 60% yield.

Preparation of Borazine Using Sodium Borohydride and Ammonium Sulfate

Sodium borohydride (25 g, 0.66 mol) and ammonium sulfate (60 g, 0.462 mol) are added to a 2 L single neck round bottom flask and the flask is sealed with a rubber septa. The reaction flask is connected via cannula to a trap that is cooled at −50° C. Diglyme (100 ml) is transferred to the reaction mixture. MgCl₂ (10 mol %) is added and the reaction mixture is stirred and gradually heated to 90° C. and maintained at the same temperature for 4 hours. Following the reaction, the borazine that have been retained in the trap is further purified by vacuum distillation in a 60% yield.

### Example 5

### Hydrogen Generation Via Methanolysis of Ammonia Borane

A complete system is achieved, wherein 3 equivalents of hydrogen is liberated from the ammonia borane by methanolysis in the presence of transition metal (TM) catalyst, and the ammonium tetramethoxyborate salt (tetramethoxy-boronic acid; ammonium salt) formed in the reaction is recycled to ammonia borane in a 80% yield in the presence of ammonium salts and lithium aluminum hydride at ambient temperature in THF.

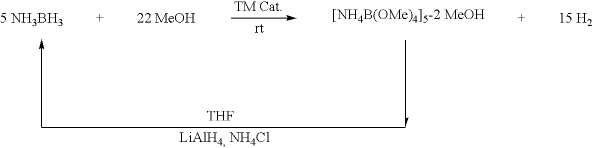

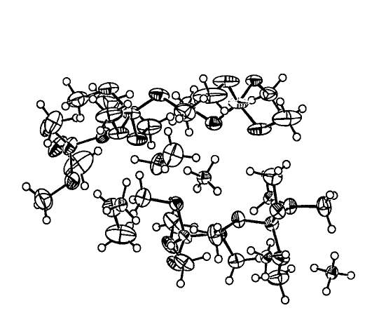

In a typical reaction procedure, a methanolic solution (methanol 4.2-4.5 equiv.) of ruthenium chloride (0.25 wt. %) is added to the solid ammonia borane. The hydrogen liberation is rapid with the exothermic reaction and all the 3 equivalents of hydrogen are produced within 4 minutes, which is measured by gas burette. The time period for the liberation of hydrogen depends on the weight percentage of transition metal catalyst. It is observed that with the increased weight percentage of catalyst, the time period for complete hydrogen evolution is shortened. When the hydrogen evolution ceases, the residual solid ammonium tetramethoxyborate salt is obtained. Sublimation (50-54° C.) provides a 87% yield of an orthorhombic crystalline material, which is confirmed as [NH₄B(OMe)₄]₅-2MeOH (X-ray structure). As shown in FIG. 1, a unit cell contains four of the following asymmetric pentamer units of ammonium borate with two methanol molecules of crystallization.

Experimental

The efficiency of transition metal catalysts for methanolysis of ammonia borane is examined. The results are summarized in Table 1.

TABLE 1
The effect of catalysts on the alcoholysis of ammonia borane

| Entry | Catalyst | Catalyst (mol %) | React. Time, min |
|---|---|---|---|
| 1 | RuCl₃ | 0.0312 | 80 |
| 2 | RuCl₃ | 0.0625 | 38 |
| 3 | RuCl₃ | 0.125 | 12 |
| 4 | RuCl₃ | 0.250 | 4 |
| 5 | RuCl₃ | 0.5 | 2 |
| 6 | RuCl₃ | 1.0 | 1 |
| 7 | RuCl₃ | 2 | 0.75 |
| 8 | RhCl₃ | 2 | 6 |
| 9 | CoCl₂ | 2 | 20 |
| 10 | NiCl₂ | 2 | 15 |
| 11 | PdCl₂ | 2 | 40 |
| 12 | CuCl₂ | 2 | 180 |
| 13 | Pd/C | 1 | 90 |
| 14 | Raney Ni | 5 | 8 |

Ammonia-borane has a solubility of 23% in methanol. This solution does not readily liberate hydrogen. However, in the presence of 0.5% ruthenium (III) chloride hydrate, ammonia-borane liberates all three equivalents of hydrogen in about 2 minutes, while 0.0625% catalyst requires 38 minutes to liberate hydrogen at ambient conditions as evidenced by ¹¹B NMR spectroscopy data. Hydrogen liberation is also observed in the presence of Co(II)Cl₂, Ni(II)Cl₂, and Pd(II)Cl₂.

The RuCl₃-catalyzed alcoholysis of ammonia borate is examined in other alcohols, such as ethanol, n-propanol and isopropanol and t-butanol. The results are summarized in Table 2.

TABLE 2
The effect of alcohols on the alcoholysis of
ammonia borane in presence of 1 mol % RuCl₃

| Entry | Alcohols | Reaction time (min) |
|---|---|---|
| 1 | Methanol | 1 |
| 2 | Ethanol | 3.5 |
| 3 | n-Propanol | 14 |
| 4 | n-Butanol | 16 |
| 5 | t-Butanol | Incomplete |
| 6 | Iso-Propanol | Incomplete |

### Example 6

### Hydrogen Generation Via Hydrolysis of Ammonia Borane

The liberation of hydrogen from ammonia-borane via hydrolysis has been examined with different transition metal chlorides. Hydrolysis catalyzed by mineral acids occurs instantly at ambient temperature. The hydrolysis of ammonia-borane (1 mmol), with 0.05% ruthenium (III) chloride hydrate, is completed within 20 minutes. By increasing the catalyst mol % to 0.1 and 0.2, the hydrolysis is completed within 6 minutes and 3 minutes, respectively. The reaction is also aided by 5 mol % PdCl₂ and 1 mol % palladized charcoal. In both cases the reaction time is 25 minutes. Total hydrogen is evolved continuously at room temperature within 5 minutes in the presence of 3% CoCl₂. When the mol % of catalyst is increased to 3 to 5%, hydrogen is evolved immediately and completed within 3 minutes.

### Example 7

### Hydrogen Generation Via Methanolysis of Borazine

It has been reported that borazine reacts with 9 equivalents of methanol to form NH₃B(OMe)₃. It is observed that when more than 12 equivalents of methanol is reacted with borazine in the presence of transition metal catalysts such as ruthenium or palladium chloride, it liberates 3 equivalents of hydrogen to form ammonium tetramethoxyborate, which can be recycled back to ammonia borane as explained below.

In a typical reaction procedure, a methanolic solution (methanol in 15-20 equivalents) of ruthenium chloride (1 mol %) is added slowly to borazine. The hydrogen liberation is rapid with the exothermic reaction and hydrogen produced is measured by analytical gas burette. The time period for the liberation of hydrogen depends on the mole percentage of the transition metal catalyst. It is observed that with the increased weight percentage of a catalyst, the time period for complete hydrogen evolution can be shortened. When the hydrogen evolution ceases, the residual solid ammonium tetramethoxyborate salt along with the ruthenium chloride catalyst is subjected to sublimation (ammonium tetramethoxyborate salt sublimes at 50°-54° C.) and is isolated

Experimental

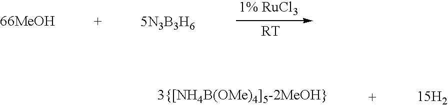

Borazine (0.405 g, 0.005 mol) is charged to a round bottom flask fitted with a septum and a reflux condenser. The end of the reflux condenser is connected to a gas burette. A solution of RuCl₃ (1 mol %) in methanol (3 mL, 0.075 mol)) is syringed into the reaction flask slowly. The reaction content is stirred at RT for 25 minutes. The evolution of hydrogen is observed with the exothermic reaction and is measured in gas burette. At the end of the reaction, semi-solid ammonium tetramethoxyborate borate is formed, which is then subjected to sublimation by heating it at 54° C. till all of the material sublimes in a yield of 87%. X-Ray crystallography shows that the compound exists as 5NH₄B(OMe)₄-2MeOH. As shown in FIG. 1, a unit cell contains four asymmetric pentamer units of ammonium borate with two methanol molecules of crystallization. ¹¹B-NMR (64 MHz, MeOH) δ (ppm) 8.7.

### Example 8

### Regeneration of Ammonia Borane from Ammonium Tetramethoxyborate

Initially, ammonium tetramethoxyborate salt is treated with lithium aluminum hydride and ammonium chloride in THF at a temperature between 0° C. and RT using atmospheric pressure to obtain ammonia borane in a 65% yield. The yield of this reaction is improved to 80% by carrying out the reaction in a sealed reactor. A suspension of lithium aluminum hydride in THF (pre-cooled to −78° C.) is added to the mixture of ammonium tetramethoxyborate and ammonium chloride in a stainless steel reactor and the reactor is sealed immediately. The reaction mixture is stirred for 8-10 hours. The reaction mixture is then concentrated and the residue is extracted using diethyl ether to afford high purity ammonia borane. This reaction can be repeated with other organic alcohols, such as ethanol, butanol, isopropanol, and the like.

Experimental

Methanolysis of Ammonia Borane

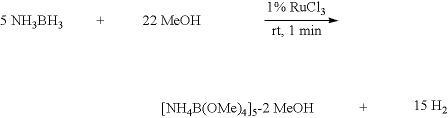

A two neck round bottom flask is equipped with a rubber septum on one neck and a reflux condenser with a rubber septum on the other neck. The end of the reflux condenser is connected to a gas burette. To this, ammonia borane (0.660 g, 0.0213 mol) is charged and a solution of RuCl₃ (1 wt. %) in methanol (3.89 ml) is added. The reaction content is stirred at RT for 25 minutes. The evolution of hydrogen is observed with the exothermic reaction and is measured in the gas burette. At the end of the reaction, solid ammonium tetramethoxyborate borate is formed, which is then subjected to sublimation by heating it at 54° C. till all the ammonium tetramethoxyborate sublimes. The sublimed pure ammonium tetramethoxyborate is then collected in a 95% yield.

Regeneration of Ammonia-Borane

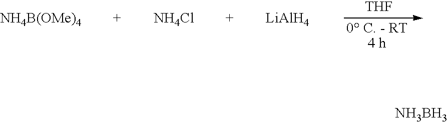

A suspension of ammonium tetramethoxyborate (0.211 g, 0.0013 mol) and ammonium chloride (0.150 g, 0.0027 mol) in tetrahydrofuran (3.5 ml) is cooled to 0° C. under nitrogen atmosphere. To this is added dropwise a suspension of lithium aluminum hydride (0.08 g, 0.0016 mol) in tetrahydrofuran (3.5 ml) over a period of 1 hour at the same temperature. The reaction mixture is allowed to warm to RT slowly and stirred continuously for another 3 hours. The reaction is monitored by ¹¹B-NMR spectroscopy. THF is removed under vacuum and the solid residue is extracted using diethyl ether (70 ml) at 0° C. for 2 hours. The reaction mixture is filtered under nitrogen atmosphere and the filtrate is concentrated under vacuum to afford ammonia borane in a 65% yield with a 98% purity.

Regeneration of Ammonia-Borane Using Sealed Reaction Vessel

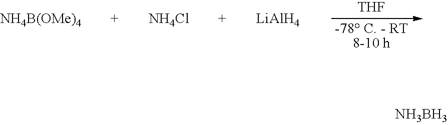

A suspension of lithium aluminum hydride (0.16 g, 0.0041 mol) in tetrahydrofuran (15 ml) is cooled to −78° C. and added at once to the mixture of ammonium tetramethoxyborate (0.422 g, 0.00268 mol) and ammonium chloride (0.3 g, 0.0055 mol) in a stainless steel reaction vessel under nitrogen atmosphere and the reaction vessel is sealed immediately. The reaction content is stirred at RT for 8 hours. THF is removed under vacuum and the solid residue is extracted using dry diethyl ether (100 ml) at 0° C. for an hour. The reaction mixture is filtered under nitrogen atmosphere and the filtrate is concentrated under vacuum to afford ammonia borane in a 80% yield with a 98% purity.

While the invention has been described with reference to certain embodiments, other features may be included without departing from the spirit and scope of the invention. It is therefore intended that the foregoing detailed description be regarded as illustrative rather than limiting, and that it be understood that it is the following claims, including all equivalents, that are intended to define the spirit and scope of this invention.

1. A process for preparing ammonia borane, the process comprising:
reacting a metal borohydride with an ammonia salt under an ambient condition, greater than about 50% of the metal borohydride being converted to ammonia borane.

2. The process of claim 1, wherein the reacting step is carried out at a temperature of about room temperature to about 40° C.

3. The process of claim 1, wherein the metal borohydride is selected from the group consisting of lithium borohydride and sodium borohydride.

4. The process of claim 3, wherein the metal borohydride comprises sodium borohydride.

5. The process of claim 1, wherein the ammonia salt is selected from the group consisting of ammonium sulfate, ammonium chloride, ammonium fluoride, ammonium carbonate, ammonium nitrate, ammonium acetate, and ammonium formate.

6. The process of claim 5, wherein the ammonia salt comprises ammonium sulfate.

7. The process of claim 6, wherein the ammonia salt comprises powdered ammonium sulfate.

8. The process of claim 6, wherein the reacting step is carried out in THF and the metal borohydride comprises sodium borohydride.

9. The process of claim 8, wherein the molar ratio of the metal borohydride to the ammonium salt is about 1:1.

10. The process of claim 5, wherein the ammonia salt comprises ammonium formate.

11. The process of claim 10, wherein the reacting step is carried out in dioxane and the metal borohydride comprises sodium borohydride.

12. The process of claim 1, wherein the molar ratio of the metal borohydride to the ammonium salt is about 1:1.5.

13. The process of claim 1, wherein the reacting step is carried out in a solvent.

14. The process of claim 13, wherein the reacting step is carried out in THF.

15. The process of claim 13, wherein the reacting step is carried out in dioxane.

16. The process of claim 1, wherein the reacting step is carried out in air.

17. The process of claim 1, wherein about 80%-96% of the metal borohydride is converted to ammonia borane.

18. A process for generating hydrogen, the process comprising:
reacting ammonia borane with a solvent in the presence of a metal catalyst at an ambient temperature, substantially all 3 equivalents of hydrogen being evolved from ammonia borane in less than about 24 hours.

19. The process of claim 18, wherein the solvent is water.

20. The process of claim 18, wherein the solvent is selected from the group consisting of methanol, ethanol, n-propanol, n-butanol, isopropanol and t-butanol.

21. The process of claim 20, wherein the solvent is methanol.

22. The process of claim 18, wherein the metal catalyst is a transition metal catalyst.

23. The process of claim 22, wherein the metal catalyst is selected from the group consisting of RuCl₃, RhCl₃, CoCl₂, NiCl₂, PdCl₂, CuCl₂, Raney Ni and Pd—C.

24. The process of claim 23, wherein the metal catalyst is selected from the group consisting of RuCl₃ and PdCl₂.

25. The process of claim 18, wherein the weight percentage of the metal catalyst is from about 0.01% to 10%.

26. The process of claim 18, wherein substantially all 3 equivalents of hydrogen being evolved from ammonia borane in less than about 2 hours.

27. A process for generating hydrogen, the process comprising:
reacting borazine with a solvent in the presence of a metal catalyst at an ambient temperature, substantially all 3 equivalents of hydrogen being evolved from borazine in less than about 24 hours.

28. A process for regenerating ammonia borane from ammonium tetramethoxyborate, the process comprising:
reacting ammonium tetramethoxyborate with an ammonium salt and a metal hydride to afford ammonia borane.

29. The process of claim 28, wherein the metal hydride is selected from the group consisting of lithium hydride, lithium aluminum hydride and sodium aluminum hydride.

30. The process of claim 29, wherein the metal hydride comprises lithium aluminum hydride.

31. The process of claim 28, wherein the ammonia salt is selected from the group consisting of ammonium sulfate, ammonium chloride, ammonium fluoride, ammonium carbonate, ammonium nitrate, ammonium acetate, and ammonium formate.

32. The process of claim 31, wherein the ammonia salt comprises ammonium chloride.

33. The process of claim 28, wherein the reacting step is carried out at a temperature of about 0° C. to about room temperature.

34. The process of claim 28, further comprising:
cooling the metal hydride before the reacting step.

35. The process of claim 28, wherein the reacting step is carried out at an atmospheric pressure.

36. The process of claim 28, wherein the reacting step is carried out in a sealed reactor.

37. The process of claim 28, wherein the reacting step is carried out in THF.

38. The process of claim 28, further comprising:
concentrating the reaction mixture to form a crude ammonia borane; and
extracting the crude ammonia borane to form a purified ammonia borane.

39. The process of claim 28, wherein greater than about 80% of the ammonium tetramethoxyborate is converted to ammonia borane.
